(19) United States
(12) Patent Application Publication
(10) Pub. No.: US 2024/0416719 A1
(43) Pub. Date: Dec. 19, 2024

(54) INFORMATION PROCESSING DEVICE

(71) Applicant: TOYOTA JIDOSHA KABUSHIKI KAISHA, Toyota-shi (JP)

(72) Inventors: Yosuke AKISHITA, Tokyo (JP); Hiroyuki BANDAI, Nagakute-shi (JP); Shunya MARUTA, Tokyo (JP)

(73) Assignee: TOYOTA JIDOSHA KABUSHIKI KAISHA, Toyota-shi (JP)

(21) Appl. No.: 18/656,023

(22) Filed: May 6, 2024

(30) Foreign Application Priority Data
Jun. 14, 2023 (JP) 2023-097961

(51) Int. Cl. B60H 1/00

(52) U.S. Cl. CPC B60H 1/00849; B60H 1/00764

(57) ABSTRACT

An information processing device includes a control unit configured to determine whether to perform switching control for switching from an outside air mode to a recirculated air mode in a vehicle, based on acquired environmental data and travel data of the vehicle. The control unit is configured to, when determination is made that the switching control is to be performed, either perform a notification process for recommending to perform the switching control, or perform the switching control.

### CROSS-REFERENCE TO RELATED APPLICATION

This application claims priority to Japanese Patent Application No. 2023-097961 filed on Jun. 14, 2023, incorporated herein by reference in its entirety.

### BACKGROUND

### 1. Technical Field

The present disclosure relates to information processing devices.

### 2. Description of Related Art

Control for switching between an outside air mode and a recirculated air mode in a vehicle is known in the art. For example, Japanese Unexamined Patent Application Publication No. 2005-335414 (JP 2005-335414 A) describes switching between a recirculated air inlet and an outside air inlet according to the cooling state of a vehicle cabin in order to improve cooling efficiency.

### SUMMARY

There is room for improvement in the timing of performing the control for switching from the outside air mode to the recirculated air mode in a vehicle.

It is an object of the present disclosure made in view of the above circumstances to improve the timing of performing the control for switching from the outside air mode to the recirculated air mode in a vehicle.

An information processing device according to an embodiment of the present disclosure includes a control unit configured to determine whether to perform switching control for switching from an outside air mode to a recirculated air mode in a vehicle, based on acquired environmental data and travel data of the vehicle. The control unit is configured to, when determination is made that the switching control is to be performed, either perform a notification process for recommending to perform the switching control, or perform the switching control.

According to the embodiment of the present disclosure, it is possible to improve the timing of performing the control for switching from the outside air mode to the recirculated air mode in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment of the present disclosure;

FIG. 2 is a sequence diagram illustrating an exemplary operation of the system shown in FIG. 1;

FIG. 3 is a diagram illustrating an exemplary setting condition; and

FIG. 4 is a flow chart showing an exemplary operation of the in-vehicle device shown in FIG. 1.

### DETAILED DESCRIPTION OF EMBODIMENTS

Hereinafter, an embodiment of the present disclosure will be described below with reference to the drawings.

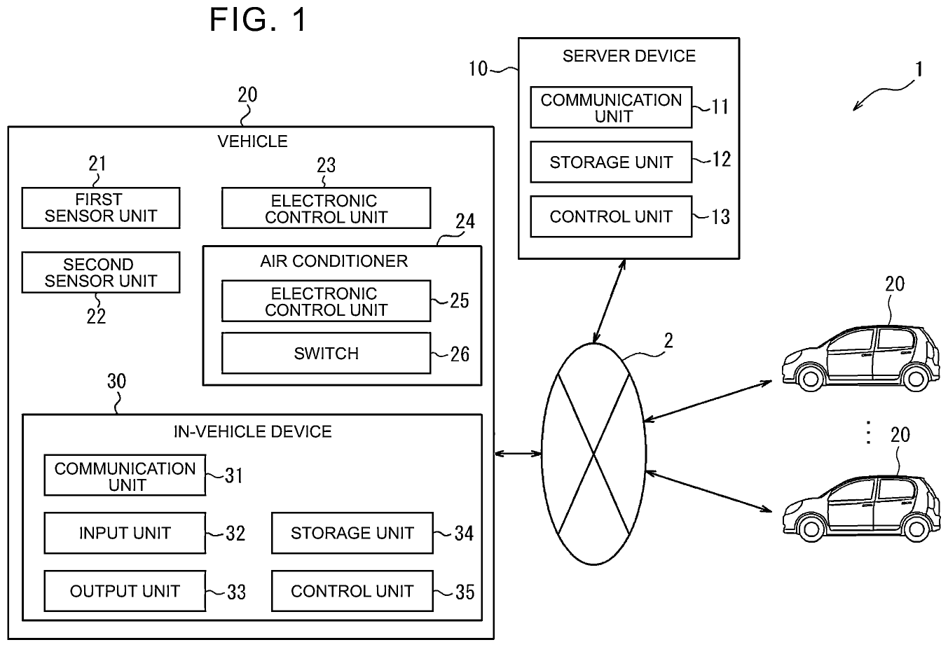

As shown in FIG. 1, a system 1 of the present embodiment includes a server device 10 and a plurality of vehicles 20. The server device 10 and the vehicle 20 can communicate with each other via the network 2. The network 2 may be any network including a mobile communication network, the Internet, and the like.

The server device 10 is an information processing device. The server device 10 is, for example, a dedicated computer configured to function as a server, a general-purpose personal computer, a cloud computing system, or the like.

The server device 10 includes a communication unit 11, a storage unit 12, and a control unit 13.

The communication unit 11 is configured to include at least one communication module that can be connected to the network 2. The communication module is, for example, a communication module compliant with a standard such as a wired Local Area Network (LAN) or a wireless LAN. The communication unit 11 is connected to the network 2 with the communication module via a wired LAN or a wireless LAN.

The storage unit 12 is configured to include at least one semiconductor memory, at least one magnetic memory, at least one optical memory, or a combination of at least two of them. The storage unit 12 may function as a main storage device, an auxiliary storage device, or a cache memory. The storage unit 12 stores data used for the operation of the server device 10 and data obtained by the operation of the server device 10.

The control unit 13 is configured to include at least one processor, at least one dedicated circuit, or a combination thereof. The processor may be, for example, a general-purpose processor such as Central Processing Unit (CPU) or Graphics Processing Unit (GPU) or a special-purpose processor specialized for a particular process. The control unit 13 performs a process related to the operation of the server device 10 while controlling each unit of the server device 10.

The vehicle 20 is, for example, an automobile such as a gasoline-powered vehicle or a hybrid electric vehicle (HEV). However, the vehicle 20 is not limited thereto. The vehicle 20 may be any type of vehicle as long as it includes an air conditioner 24 described later and is driven by fuel such as gasoline.

The vehicle 20 includes a first sensor unit 21, a second sensor unit 22, an electronic control unit 23, an air conditioner 24, and an in-vehicle device 30.

The first sensor unit 21 is capable of detecting the vehicle cabin temperature and the vehicle cabin humidity of the vehicle 20. The first sensor unit 21 includes a temperature sensor and a humidity sensor. The first sensor unit 21 may be disposed in the cabin of the vehicle 20.

The second sensor unit 22 is capable of detecting the ambient temperature and the ambient humidity of the vehicle 20. The second sensor unit 22 includes a temperature sensor and a humidity sensor. At least a portion of the second sensor unit 22 may be disposed outside the vehicle 20. The ambient temperature of the vehicle 20 is also referred to as the outside air temperature of the vehicle 20.

The electronic control unit 23 is an Electronic Control Unit (ECU) of the vehicles 20. The electronic control unit 23 controls various functions of the vehicle 20.

The air conditioner 24 is capable of cooling the cabin of the vehicle 20. The air conditioner 24 may be capable of heating the cabin of the vehicle 20. The air conditioner 24 may be a so-called air-conditioner or air-conditioning device in a case where the cabin of the vehicle 20 can be heated.

The air conditioner 24 has an outside air mode and a recirculated air mode as operation modes. The outside air mode is a mode in which air outside the vehicle 20, that is, outside air, is introduced into the cabin of the vehicle 20. The recirculated air mode is a mode in which air inside the cabin of the vehicle 20 is recirculated. In the recirculated air mode, the entry of outside air into the cabin of the vehicle 20 may be blocked. A default operation mode of the air conditioner 24 is the outside air mode.

The air conditioner 24 includes an electronic control unit 25 and a switch 26.

The electronic control unit 25 is an ECU of the vehicles 20. The electronic control unit 25 controls the air conditioner 24.

The electronic control unit 25 is capable of performing switching control. The switching control is control for switching from the outside air mode to the recirculated air mode in the vehicle 20. The switching control according to the present embodiment is control for switching the operation mode of the air conditioner 24 from the outside air mode to the recirculated air mode according to the outside air temperature of the vehicle 20. For example, when the outside air temperature of the vehicle 20 exceeds the set temperature, the electronic control unit 25 switches the operation mode of the air conditioner 24 from the outside air mode to the recirculated air mode. When the outside air temperature of the vehicle 20 is equal to or lower than the set temperature, the electronic control unit 25 maintains the default operation mode of the air conditioner 24, namely the outside air mode. The set temperature may be set according to an environment in which the vehicle 20 travels. The set temperature is, for example, 26 degrees. The electronic control unit 25 may acquire the outside air temperature of the vehicle 20 from the second sensor unit 22. The electronic control unit 25 may switch the operation mode of the air conditioner 24 to the recirculated air mode when an instruction to execute the recirculated air mode is received from an external button etc.

The switch 26 is operated by a user of the vehicle 20. The switch 26 is a switch for switching whether to perform the switching control. When the switch 26 is switched to perform the switching control, the electronic control unit 25 performs the switching control. When the switch 26 is switched to not perform the switching control, the electronic control unit 25 does not perform the switching control. When the switching control is not performed, in the present embodiment, the air conditioner 24 operates in the external introduction mode of the initial setting.

The in-vehicle device 30 is an information processing device. The in-vehicle device 30 is, for example, a navigation device. The in-vehicle device 30 includes a communication unit 31, an input unit 32, an output unit 33, a storage unit 34, and a control unit 35.

The communication unit 31 is configured to include at least one communication module that can be connected to the network 2. The communication module is a communication module compliant with a mobile communication standard such as Long Term Evolution (LTE), 4th Generation (4G), or 5th Generation (5G), for example.

The communication unit 31 includes at least one communication module that can communicate with the first sensor unit 21, the second sensor unit 22, the electronic control unit 23, and the electronic control unit 25. The communication module is, for example, a communication module corresponding to a standard of an in-vehicle network or a dedicated line.

The input unit 32 can receive an input from a user. The input unit 32 includes at least one input interface capable of accepting input from a user. The input interface is, for example, a physical key, a capacitive key, a pointing device, a touch screen integrated with a display, or a microphone.

The output unit 33 can output data. The output unit 33 includes at least one output interface capable of outputting data. The output interface is, for example, a display or a speaker. The display is, for example, a Liquid Crystal Display (LCD) or an organic Electro Luminescence (EL) display.

The configuration of the storage unit 34 may be the same as or similar to the configuration of the storage unit 12. The storage unit 34 stores data used for the operation of the in-vehicle device 30 and data obtained by the operation of the in-vehicle device 30. For example, the storage unit 34 stores information on the model of the vehicle 20.

The configuration of the control unit 35 may be the same as or similar to that of the control unit 13. The control unit 35 perform a process related to the operation of the in-vehicle device 30 while controlling each unit of the in-vehicle device 30.

### System Operation

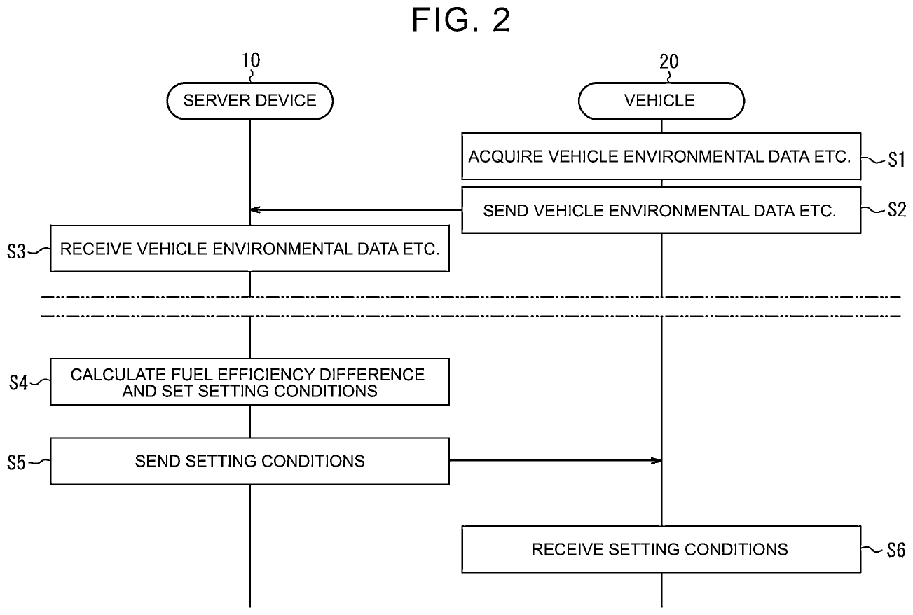

FIG. 2 is a sequence diagram showing an operation of the system 1 shown in FIG. 1.

Steps S1 and S2 may be performed by the in-vehicle device 30 of the vehicle 20 of any one of the plurality of vehicles 20 included in the system 1.

In step S1, in the in-vehicle device 30, the control unit 35 acquires the environmental data of the vehicle 20. The environmental data of the vehicle 20 includes, for example, time-series data of the vehicle cabin temperature of the vehicle 20, time-series data of the vehicle cabin humidity of the vehicle 20, time-series data of the surrounding temperature of the vehicle 20, and time-series data of the surrounding humidity of the vehicle 20. The control unit 35 sequentially receives data of the vehicle cabin temperature and vehicle cabin humidity of the vehicle 20 detected by the first sensor unit 21 by the communication unit 31, thereby acquiring time-series data of the vehicle cabin temperature and vehicle cabin humidity of the vehicle 20. The control unit 35 acquires time-series data of the ambient temperature and the ambient humidity of the vehicle 20 by sequentially receiving the data of the ambient temperature and the ambient humidity of the vehicle 20 detected by the second sensor unit 22 by the communication unit 31.

In step S1, the control unit 35 acquires travel data of the vehicles 20. The travel data of the vehicle 20 includes, for example, trip time data of the vehicle 20 and fuel efficiency data of the vehicle 20 per trip time. The trip time is a time during which the vehicle 20 travels from the departure point to the destination. The fuel efficiency of the vehicle 20 is the travel distance of the vehicle 20 per unit capacity of the fuel. The control unit 35 acquires travel data of the vehicle 20 by communicating with the electronic control unit 23 via the communication unit 31.

In step S1, the control unit 35 acquires the usage history of the air conditioner 24. The data of the usage history of the air conditioner 24 includes, for example, data of a time period in which the cabin of the vehicle 20 is cooled, a time period in which the switching control is in operation, and a time period in which the switching control is not in operation. The control unit 35 acquires data of the usage history of the air conditioner 24 by communicating with the electronic control unit 25 via the communication unit 31.

In step S1, the control unit 35 acquires the model of the vehicle 20 from the storage unit 34.

In step S2, the control unit 35 sends the environmental data of the vehicle 20, the travel data of the vehicle 20, the data of the usage history of the air conditioner 24, and the model information of the vehicle 20 to the server device 10 via the network 2 by the communication unit 31.

In step S3, in the server device 10, the control unit 13 receives the environmental data of the vehicle 20, the travel data of the vehicle 20, the data of the usage history of the air conditioner 24, and the model information of the vehicle 20 from the vehicle 20 via the network 2 by the communication unit 11. The control unit 13 stores the received environmental data and the like of the vehicle 20 in the storage unit 12.

Steps S1 to S3 may be repeatedly performed for a predetermined time. The predetermined period may be set based on the travel frequency of the plurality of vehicles 20 included in the system 1. By repeatedly performing steps S1 to S3, environmental data etc. of the plurality of vehicles 20 are accumulated in the storage unit 12 of the server device 10.

In step S4, in the server device 10, the control unit 13 acquires environmental data and the like of the plurality of vehicles 20 accumulated in the storage unit 12. The control unit 13 calculates a fuel efficiency difference in the vehicle 20 based on the acquired data etc.

In the present disclosure, the fuel efficiency difference in the vehicle 20 is obtained by subtracting the fuel efficiency of the vehicle 20 when the switching control is not in operation from the fuel efficiency of the vehicle 20 when the switching control is in operation when the cabin of the vehicle 20 is being cooled. That is, when the cabin of the vehicle 20 is being cooled, the larger the fuel efficiency difference in the vehicle 20, the higher the fuel efficiency of the vehicle 20 when the switching control is in operation is than the fuel efficiency of the vehicle 20 when the switching control is not in operation. As described above, the fuel efficiency of the vehicle 20 is the travel distance of the vehicle 20 per unit capacity of the fuel. Therefore, the higher the fuel efficiency of the vehicle 20, the better the fuel efficiency of the vehicle 20. When the fuel efficiency of the vehicle 20 is improved, it means that the vehicle 20 travels a greater distance with a smaller amount of fuel.

The fuel efficiency difference of the vehicle 20 depends on either or both of the environmental condition and travel condition of the vehicle 20, as exemplified below.

As an example of such dependence, there is a condition that the ambient temperature of the vehicle 20 is higher than the vehicle cabin temperature and the set temperature of the vehicle 20 and the trip time of the vehicle 20 is shortened. Under this condition, the fuel efficiency of the vehicle 20 when the switching control is in operation is higher than the fuel efficiency of the vehicle 20 when the switching control is not in operation. That is, the fuel efficiency difference of the vehicle 20 is large. This is because, when the switching control is performed, the operation mode of the air conditioner 24 is switched to the recirculated air mode because the ambient temperature of the vehicle 20 is higher than the set temperature. When the operation mode of the air conditioner 24 is switched to the recirculated air mode, the outside air at a temperature higher than the vehicle cabin temperature of the vehicle 20 is not introduced into the cabin of the vehicle 20, so that the cabin of the vehicle 20 can be cooled efficiently. When the cabin of the vehicle 20 can be cooled efficiently, the fuel efficiency of the vehicle 20 increases.

As an example of the above dependence, there is a condition that the vehicle cabin temperature of the vehicle 20 is higher than the ambient temperature of the vehicle 20 and the ambient temperature of the vehicle 20 is higher than the set temperature. Under this condition, the fuel efficiency of the vehicle 20 when the switching control is not in operation is higher than the fuel efficiency of the vehicle 20 when the switching control is in operation. That is, the fuel efficiency difference of the vehicle 20 is reduced. This is because, under this condition, the vehicle cabin temperature of the vehicle 20 is higher than the ambient temperature of the vehicle 20, and therefore introducing the outside air into the cabin of the vehicle 20 can more efficiently cool the vehicle interior of the vehicle 20. That is, when the switching control is performed, the operation mode of the air conditioner 24 is switched to the recirculated air mode because the ambient temperature of the vehicle 20 is higher than the set temperature. As a result, the outside air of the vehicle 20 is not introduced into the vehicle cabin. When the outside air is not introduced into the cabin of the vehicle 20, the cabin of the vehicle 20 cannot be cooled efficiently. When the cabin of the vehicle 20 cannot be cooled efficiently, the fuel efficiency of the vehicle 20 is reduced.

As described above, the fuel efficiency difference of the vehicle 20 depends on either or both of the environmental condition and travel condition of the vehicle 20. Therefore, the control unit 13 identifies either or both of the environmental condition and travel condition of the vehicle 20 under which the fuel efficiency difference is large, and sets the setting condition of the vehicle 20 under which the fuel efficiency difference is large. The control unit 13 may identify either or both of the environmental condition and travel condition of the vehicle 20 under which the fuel efficiency difference is large, thereby identify the setting condition of the vehicle 20 under which the fuel efficiency difference is large, thereby setting the setting condition of the vehicle 20 under which the fuel efficiency difference is large. For example, the control unit 13 divides the environmental data and travel data of the vehicle 20 accumulated in the storage unit 12 into data groups. The control unit 13 calculates the fuel efficiency difference in each data group based on the data of the usage history of the air conditioner 24, thereby identifying either or both of the environmental condition and travel condition of the vehicle 20 under which the fuel efficiency difference of the vehicle 20 is large.

The structures of the air conditioner 24 or the vehicle cabin etc. vary depending on the model of the vehicle 20. Therefore, even under the same environmental condition and travel condition, the setting condition for the vehicle 20 under which the fuel efficiency difference is large may vary depending on the model of the vehicle 20. Therefore, the control unit 13 may set the setting condition for each model of the vehicle 20. By setting the setting condition for each model of the vehicle 20, it is possible to set the setting condition of the vehicle 20 in which the fuel efficiency difference becomes larger.

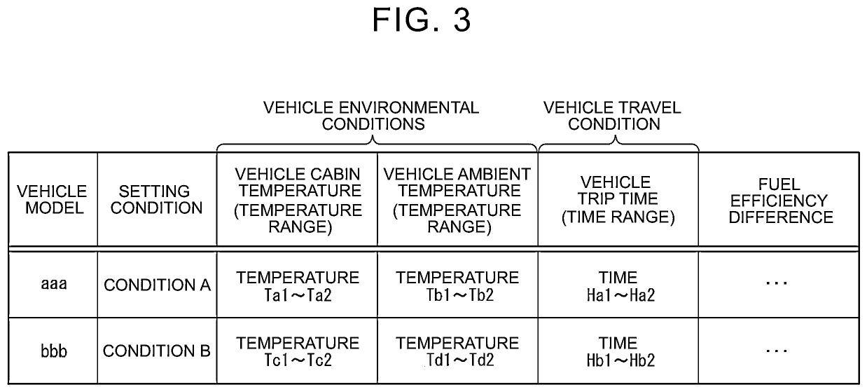

For example, the control unit 13 sets the setting condition as shown in FIG. 3. In FIG. 3, the setting condition is set for each of the following models of the vehicle 20: “aaa” and “bbb”. In the vehicle model “aaa”, the condition A is set as a setting condition under which the fuel efficiency difference is large. In the condition A, the range of the vehicle cabin temperature of the vehicle 20 from the temperature Ta1 to the temperature Ta2 and the range of the ambient temperature of the vehicle 20 from the temperature Tb1 to the temperature Tb2 are set as the environmental condition of the vehicle 20. In the condition A, the trip time from the time Ha1 to the time Ha2 is set as the travel condition of the vehicle 20. In the vehicle model with “bbb”, the condition B is set as a setting condition under which the fuel efficiency difference is large. In the condition B, the range of the vehicle cabin temperature of the vehicle 20 from the temperature Tc1 to the temperature Tc2 and the range of the ambient temperature of the vehicle 20 from the temperature Td1 to the temperature Td2 are set as the environmental condition of the vehicle 20. In the condition B, the trip time from the time Hb1 to the time Hb2 is set as the travel condition of the vehicle 20.

In step S5, the control unit 13 sends the setting condition data for each vehicle model to each of the plurality of vehicles 20 included in the system 1 by the communication unit 11 via the network 2.

In step S6, in the in-vehicle device 30 of the vehicle 20, the control unit 35 receives, by the communication unit 31, data of setting conditions for each vehicle model from the server device 10 via the network 2. The control unit 35 stores the received data of the setting condition for each vehicle model in the storage unit 34.

### Operation of In-Vehicle Device

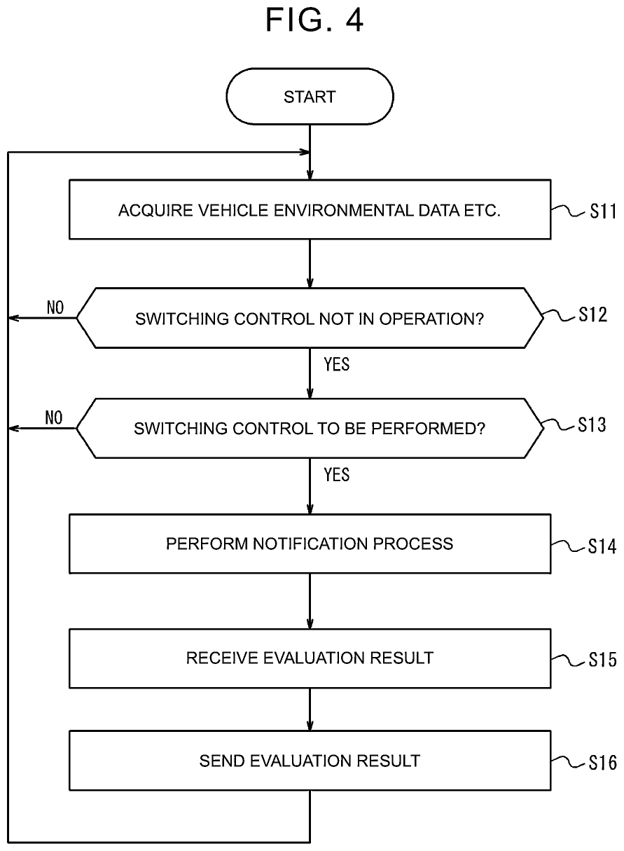

FIG. 4 is a diagram illustrating an example of the operation of the in-vehicle device 30 shown in FIG. 1. It is assumed that step S6 has been performed before step S11. That is, it is assumed that the storage unit 34 stores data of setting conditions for each vehicle model. For example, when the ignition of the vehicle 20 is turned from the off-state to the on-state, the control unit 35 starts step S11.

In step S11, the control unit 35 acquires the environmental data of the vehicles 20. The environmental data of the vehicle 20 includes, for example, the vehicle cabin temperature of the vehicle 20, the vehicle cabin humidity of the vehicle 20, the ambient temperature of the vehicle 20, and the ambient humidity of the vehicle 20. The control unit 35 acquires the vehicle cabin temperature of the vehicle 20 and the vehicle cabin humidity of the vehicle 20 from the first sensor unit 21. The control unit 35 acquires the ambient temperature of the vehicle 20 and the ambient humidity of the vehicle 20 from the second sensor unit 22.

In step S11, the control unit 35 acquires travel data of the vehicles 20. The travel data of the vehicle 20 includes, for example, data of a trip time of the vehicle 20. When the vehicle 20 has not started to travel, the control unit 35 may calculate the trip time of the vehicle 20 from the travel route along which the vehicle 20 is to travel.

In step S11, the control unit 35 acquires the usage status of the air conditioner 24. The data of the usage state of the air conditioner 24 includes, for example, data indicating whether the cabin of the vehicle 20 is being cooled, and data indicating whether the switching control is in operation. The control unit 35 communicates with the electronic control unit 25 via the communication unit 31 to acquire data on the usage status of the air conditioner 24.

In step S12, the control unit 35 determines whether the cabin of the vehicle 20 is being cooled and the switching control is not in operation, based on the usage status of the air conditioner 24 acquired in step S11.

When the control unit 35 determines that the cabin of the vehicle 20 is being cooled and the switching control is not in operation (S12: YES), the process proceeds to step S13. On the other hand, when the control unit 35 determines that the cabin of the vehicle 20 is being cooled and the switching control is not in operation (S12: NO), the process returns to step S11 after a predetermined period of time has elapsed. The predetermined time may be set based on the travel speed of the vehicle 20 or the like.

In step S13, the control unit 35 determines whether to perform the switching control. The control unit 35 determines whether the environmental data and travel data of the vehicle 20 acquired in S11 satisfy the setting condition for the same vehicle model as the vehicle stored in the storage unit 34. When the control unit 35 determines that the environmental data and travel data of the vehicle 20 acquired in S11 satisfy the setting condition for the same vehicle model as the vehicle, the control unit 35 determines that the switching control is to be performed. When it is determined that the environmental data and travel data of the vehicle 20 acquired in S11 do not satisfy the setting condition for the same vehicle model as the vehicle, the control unit 35 determines that the switching control is not to be performed.

For example, it is assumed that the setting conditions shown in FIG. 3 are stored in the storage unit 34. It is herein assumed that the model of the host vehicle is “aaa”. In this case, the control unit 35 determines that the condition A is satisfied when the vehicle cabin temperature of the vehicle 20 acquired in step S11 is in the range from the temperature Ta1 to Ta2, the ambient temperature is in the range from the temperature Tb1 to Tb2, and the trip time is in the range from the time Ha1 to Ha2. When it is determined that the condition A is satisfied, the control unit 35 determines that the switching control is to be performed.

When the control unit 35 determines that the switching control is to be performed (S13: YES), the process proceeds to step S14. On the other hand, when the control unit 35 determines that the switching control is not to be performed (S13: NO), the process returns to step S11 after a predetermined period of time has elapsed.

In step S14, the control unit 35 performs a notification process. The notification process is a process for recommending to perform the switching control. In the present embodiment, the control unit 35 causes the output unit 33 to output a notification recommending to perform the switching control. As an example, the control unit 35 causes the speaker of the output unit 33 to output a sound “switching control recommended”. As another example, the control unit 35 causes the display of the output unit 33 to display a character “switching control is recommended”.

When step S14, that is, the notification process, is performed, the user of the vehicle 20 considers whether to perform the switching control. When the user selects to perform the switching control, the user operates the switch 26 to cause the electronic control unit 25 to perform the switching control. Depending on conditions such as the ambient humidity of the vehicle 20 or the indoor temperature of the vehicle 20, the windshield etc. of the vehicle 20 may become cloudy when the switching control is performed. In this case, the user selects not to perform the switching control.

After step S14, the user inputs the evaluation result from the input unit 32. The evaluation result indicates whether having performed the switching control or not performing the switching control impedes travel of the vehicle 20. For example, when the switching control is performed, the windshield may become cloudy, and the field of view in front of the vehicle 20 may become unclear. In this case, the user enters via the input unit 32 an evaluation result indicating that performing the switching control impedes travel of the vehicle 20.

In step S15, the control unit 35 receives the evaluation result from the input unit 32.

In S16, the control unit 35 sends, by the communication unit 31, the evaluation result received in S15, the vehicle model information of the vehicle 20, and the environmental data and travel data of the vehicle 20 acquired in S11 to the server device 10 via the network 2. In the server device 10, the control unit 13 receives an evaluation result or the like from the vehicle 20 via the network 2. The control unit 13 causes the storage unit 12 to store the received evaluation result in association with the vehicle model, environmental data, and travel data of the vehicle 20.

After step S16, the control unit 35 returns to step S11 after a predetermined period of time has elapsed.

In S11 that is performed again, the control unit 35 may calculate the trip time based on the travel route along which the vehicle 20 has traveled and the travel route along which the vehicle 20 is to travel. In steps S11 to S16 that are repeatedly performed, the control unit 35 may end the process shown in FIG. 4 when the vehicle 20 arrives at the destination. By repeatedly performing S11, the control unit 35 can acquire the same data as the environmental data of the vehicle 20, travel data of the vehicle 20, and data of the usage history of the air conditioner 24 that are acquired in S1. Therefore, the control unit 35 may send, by the communication unit 31, the data acquired in step S11 that has been repeatedly performed to the server device 10 via the network 2 together with the information on the model of the vehicle 20 prior to ending the process shown in FIG. 4. This process corresponds to step S2.

When the control unit 35 determines that the switching control is to be performed (S13: YES), the control unit 35 may not perform step S14 and the electronic control unit 25 may perform the switching control. With such a configuration, the switching control is automatically performed. Therefore, the convenience of the user can be improved.

When the plurality of vehicles 20 performs step S16, the storage unit 12 of the server device 10 stores the evaluation results etc. In the server device 10, the control unit 13 may identify an impeding condition based on data such as the evaluation results accumulated in the storage unit 12. The impeding condition is a condition in which travel of the vehicle 20 is impeded when the switching control is performed while the cabin of the vehicle 20 is being cooled. The impeding condition may be set based on the environmental data and travel data of the vehicle 20. Here, the structure of the vehicle 20 varies depending on the model of the vehicle 20. Therefore, even in the same environmental condition and travel condition, the impeding condition may vary depending on the model of the vehicle 20. Therefore, the control unit 13 may identify the impeding condition for each model of the vehicle 20. The control unit 13 may send, by the communication unit 11, the identified impeding condition for each model of the vehicle 20 to each of the plurality of vehicles 20 included in the system 1 via the network 2. In the in-vehicle device 30 mounted on the vehicle 20, the control unit 35 may receive, by the communication unit 31, the impeding condition for each model of the vehicle 20 from the server device 10 via the network 2. The control unit 35 may store the received impeding condition for each model of the vehicle 20 in the storage unit 34. In this case, even when the control unit 35 determines in S13 that the switching control is to be performed, S14, that is, the notification process, need not be performed when the environmental data and travel data of the vehicle 20 acquired in S11 satisfy the impeding requirement set for the model of the vehicle. That is, the control unit 35 may not proceed to step S14 but may return to step S11. With such a configuration, it is possible to reduce the possibility that travel of the vehicle 20 may be impeded by performing the switching control.

As described above, in the in-vehicle device 30 that is the information processing device, the control unit 35 determines whether to perform the switching control based on the acquired environmental data and travel data of the vehicle 20. When the control unit 35 determines that the switching control is to be performed, either the control unit 35 performs a notification process for recommending to perform the switching control, or the electronic control unit 25 performs the switching control. With such a configuration, for example, the switching control can be performed at such a timing that the fuel efficiency of the vehicle 20 is improved according to the environmental data and travel data of the vehicle 20. Therefore, according to the present embodiment, it is possible to improve the timing of performing the control for switching from the outside air mode to the recirculated air mode in the vehicle 20.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above embodiment, the in-vehicle device 30 as the information processing device determines whether to perform the switching control. However, the information processing device that determines whether to perform the switching control is not limited to the in-vehicle device 30. Any information processing device may determine whether to perform the switching control. As another example, the server device 10 that is an information processing device may determine whether to perform the switching control, and may either perform a notification process for recommending to perform the switching control, or perform the switching control. In this case, the control unit 13 may calculate the total fuel efficiency difference for each model of the vehicle 20 by multiplying the number of vehicles for each model of the vehicle 20 by the fuel efficiency difference for each model of the vehicle 20. The control unit 13 may send, by the communication unit 11 via the network 2, a notification recommending to perform the switching control to the vehicle 20 of the model in which the total fuel efficiency difference exceeds the predetermined value. The predetermined value may be set in consideration of, for example, the cost of sending the notification. By sending the notification to the vehicle 20 of the model whose total fuel efficiency difference exceeds the predetermined value, the fuel efficiencies of the plurality of vehicles 20 can be efficiently improved. In addition, the notification can be intensively sent to the vehicle 20 of the model in which the fuel efficiency is improved.

What is claimed is:

1. An information processing device comprising a control unit configured to determine whether to perform switching control for switching from an outside air mode to a recirculated air mode in a vehicle, based on acquired environmental data and travel data of the vehicle, wherein
the control unit is configured to, when determination is made that the switching control is to be performed, either perform a notification process for recommending to perform the switching control, or perform the switching control.

2. The information processing device according to claim 1, wherein:
the control unit is configured to determine that the switching control is to be performed when the acquired environmental data and travel data of the vehicle satisfy a setting condition;
the setting condition is a condition under which a fuel efficiency difference is large, and is set based on either or both of an environmental condition of the vehicle and a travel condition of the vehicle; and
the fuel efficiency difference is obtained by subtracting a fuel efficiency of the vehicle when the switching control is not in operation from a fuel efficiency of the vehicle when the switching control is in operation when a cabin of the vehicle is being cooled.

3. The information processing device according to claim 2, wherein a plurality of the setting conditions is set for each vehicle model.

4. The information processing device according to claim 1, wherein:
the information processing device is an in-vehicle device further including an output unit; and
the control unit is configured to cause, as the notification process, the output unit to output a notification recommending to perform the switching control.

5. The information processing device according to claim 4, wherein:
the in-vehicle device further includes an input unit;
the control unit is configured to, after causing the output unit to output the notification, cause the input unit to receive an evaluation result indicating whether having performed the switching control or not performing the switching control impedes travel of the vehicle;
an impeding condition is identified based on the evaluation result, the impeding condition being a condition under which the travel of the vehicle is impeded when the switching control is performed; and
the control unit is configured to, even when the determination is made that the switching control is to be performed, not cause the output unit to output the notification when the acquired environmental data and travel data of the vehicle satisfy the impeding condition.
